(19) United States
(12) Patent Application Publication
(10) Pub. No.: US 2004/0013574 A1
(43) Pub. Date: Jan. 22, 2004

(54) Specimen collection tube assembly with differentiated components

(75) Inventor: Hugh T. Conway, Verona, NJ (US)

Correspondence Address: HOFFMANN & BARON, LLP, 6900 JERICHO TURNPIKE, SYOSSET, NY, 11791, US

(73) Assignee: BECTON, DICKINSON AND COMPANY, Franklin Lakes, NJ

(21) Appl. No.: 10/198,479

(22) Filed: Jul. 18, 2002

(51) Int. Cl. B01L 3/14

(52) U.S. Cl. 422/102

(57) ABSTRACT

A tube assembly useful for the collection of body fluid samples includes a first elongate tube with an opened end and an inside diameter and a closed end section with an outside diameter. The tubes may be formed of different respective materials. The first tube includes a receptacle therefor for receiving a fluid sample that is accessible from the open end. A second elongate tube, substantially identical to the first tube, is included in the tube assembly. The closed end section outside diameter is less than the inside diameter of the opened end of the second tube. The first tube closed end section is conjugately disposed in the open end of the second tube so that the first tube and second tube are substantially axially aligned, forming a single tube assembly.

### BACKGROUND OF THE INVENTION

1. Field of the Invention

The subject invention relates to assemblies of tubes for storing collected specimens.

2. Description of the Related Art

Closed-bottom tubes are employed widely in the medical industry for storing bodily fluids prior to and during analysis. Most prior art tubes are injection molded or extruded from a plastic material and include a cylindrical side wall, a semi-spherical bottom wall and an open top. Prior art tubes are provided in a relatively small number of standard sizes to ensure compatibility with equipment employed in a laboratory or health care facility. For example, evacuated tubes used for phlebotomy must be dimensioned cross-sectionally for slidable insertion into the open end of a prior art needle holder. Similarly, many tubes are used with laboratory equipment, such as a centrifuge or apparatus for optical or electro-optical scanning of a specimen. Tubes used with such equipment must have a size compatible with the equipment in which the tube is inserted. Many tubes also are stored and shipped in a vertical orientation by placing the tube in a rack that has a plurality of cylindrical receptacles for slidably receiving the respective tubes. In view of these requirements, prior art tubes typically have cross-sectional diameters of either 16 mm or 13 mm and lengths of either 75 mm, 100 mm or 125 mm. These dimensions of the tubes, of course, affect the volume capacity of the respective tubes.

The volume of air in a specimen tube increases as the volume of the collected specimen in the tube decreases. Partly filled tubes may complicate certain optical inspections and create the risk for increased agitation as the specimen in a partly filled tube is moved from one location to another. Physical motion or turbulence in the enlarged space of the test tube can disrupt the clinical measurements; e.g., such turbulence could initiate platelet clotting, which is activated by shear stress. Accordingly, there is a strong preference for substantially filling tubes with the collected specimens.

The above-described standard sizes for tubes were developed in view of the volume of specimens that had been required to perform various analytical tests. However, fairly recent advances to test equipment have reduced the required volume of specimens to perform many analytical tests. Thus, health care workers routinely have obtained larger volumes of specimens from patients than required for the analytical test so that the specimen tubes can be substantially filled. Alternatively, health care workers obtain the proper amount of a specimen for a particular test, but only partly fill the standard specimen tube, thereby creating the above-described problems.

Several efforts have been made in recent years to address these conflicting specifications for specimen collection and analysis. For example, false-bottom tubes have been made with a relatively small interior volume to conform with the needs of the analytical equipment, but with an outer external shape that approximates the standard external shape for the storage equipment and test equipment in which the tube is placed. However, the differences between the external shape of a conventional large tube and the external shape of some false-bottom tubes have created tube handling problems. One effective approach to addressing the competing demands of tube sizes is shown in U.S. Pat. No. 5,942,191 which is assigned to the assignee of the subject invention. U.S. Pat. No. 5,942,191 shows an assembly of two tubes than can be nested with one another. Each of the two tubes has a cross-section that conforms to a conventional cross-section for prior art tubes. Additionally, the two tubes can be nested with one another to provide an overall length substantially equal to one of the above specified conventional tube lengths. Thus, the top tube of the assembly can be used to receive, store and analyze a collected specimen. The bottom tube of the assembly is provided merely to meet the dimensional demands of the equipment with which the tubes are used for storage and analysis.

Most prior art tubes are molded or extruded from a substantially inert plastic material that will provide appropriate protection for the specimen collected in the tube. For example, PET is known to provide superior vacuum retention, and hence is used for many evacuated blood collection tubes. Specimens that will be subjected to an optical or electro-optical inspection must be stored in tubes that have a high degree of transparency. Other specimens that may be affected by UV radiation may be stored in tubes formed from a material that blocks UV radiation. Plastics selected to meet these particular demands often are fairly expensive, but have been selected and used in view of the superior performance as compared to less expensive plastics.

### SUMMARY OF THE INVENTION

The subject invention is directed to an assembly of tubes that comprises a first upper tube and at least a second lower tube. Each tube has a top end, a bottom end and a tubular wall extending between the ends. The tubular wall may be substantially cylindrical, but can assume non-cylindrical shapes in accordance with needs of a particular system. The top end of each tube is open, and the bottom end of at least the upper tube is closed. The closed bottom end of the upper tube is configured to be nested within the open top of the lower tube. Certain embodiments may have a plurality of lower tubes, and the bottom of one of the lower tubes can be nested in the open top of another of the lower tubes.

The tube assembly may further include a stopper for closing the open top end of the upper tube.

The tubes of the assembly are formed from different respective materials. For example, the upper tube may be formed from a material such as polyethylene terephthalate (PET), polyethylene naphthalate (PEN), or combinations thereof that are known to provide superior vacuum retention. The one or more lower tubes may be formed from polyethylene or polypropylene in view of their lower cost and ease of assembly.

The differences between the respective tubes of the assembly also may relate to color. For example, the upper tube may be transparent to allow visibility of the contents of the upper tube, while the one or more lower tubes may be formed from a material that is opaque or black to facilitate an interface with electronic detectors on automatic instruments. The one or more lower tubes may be red to simulate the appearance of blood. In other embodiments, the upper tube may be amber to block light, and to thereby preserve the specimen for certain tests, such as bilirubin testing. The differences between the tubes also may relate to color coding. For example, the lower tube may be lavender for CBC and green for plasma. These color codes conform to conventional color codes employed for stoppers on prior art tubes. However, color coded lower tubes can be less expensive than color-coded stoppers.

In another embodiment, the subject invention is directed to a tube assembly that is made up of an upper tube, an intermediate tube, and a lower tube. The upper tube has an open top, a closed bottom, and a tubular side wall extending between the top and bottom. The side wall has a diametrically small lower portion adjacent the bottom and a diametrically large upper portion adjacent the top. The side wall also has a step transition area between the upper and lower portions. The intermediate tube has an open top, a bottom, and a tubular side wall extending between the top and bottom. The lower portion of the upper tube is nested in the open top of the intermediate tube. The lower tube has an open top, a bottom and a tubular side wall extending between the top and bottom. Portions of the intermediate tube adjacent the bottom of the intermediate tube are nested in portions of the lower tube adjacent the open top of the lower tube. The upper tube is formed from a first selected material. The intermediate and lower tubes are formed from a material different from the first selected material.

The tubes may be configured to provide a fairly permanent assembly in their nested condition. In this regard, a permanent connection can be achieved by ribs that provide an interference fit or by recesses and ribs that snap together adjacent the interface of the tubes. Such ribs may be axially or circumferentially oriented in the tube. Alternatively, the tubes may be configured to facilitate disassembly and reassembly.

The differences between the tubes in the assembly may also relate to relative dimensions. For example, the upper tube may have a length selected to achieve the minimum required volume of a specimen for a particular test. The lower tube then may have a length selected so that the assembled upper and lower tubes achieve a specified length that conforms with the dimensional requirements for the analytical, testing or storage equipment with which the tubes will be used.

### DESCRIPTION OF THE DRAWINGS

FIG. 1 is an exploded perspective view of a tube assembly in accordance with the subject invention.

FIG. 2 is a perspective view of the assembled components of the tube assembly shown in FIG. 1.

FIG. 3 is a cross-sectional view taken along line 3-3 in FIG. 1.

FIG. 4 is a cross-sectional view taken along lines 4-4 in FIG. 2.

FIG. 5 is a perspective view of a second embodiment of a tube assembly in accordance with the subject invention.

FIG. 5A is a perspective view of a third embodiment of a tube assembly in accordance with the subject invention.

FIG. 6 is a perspective view of a fourth embodiment of the tube assembly in accordance with the subject invention.

FIG. 7 is a perspective view of a fifth embodiment of the tube assembly.

### DETAILED DESCRIPTION

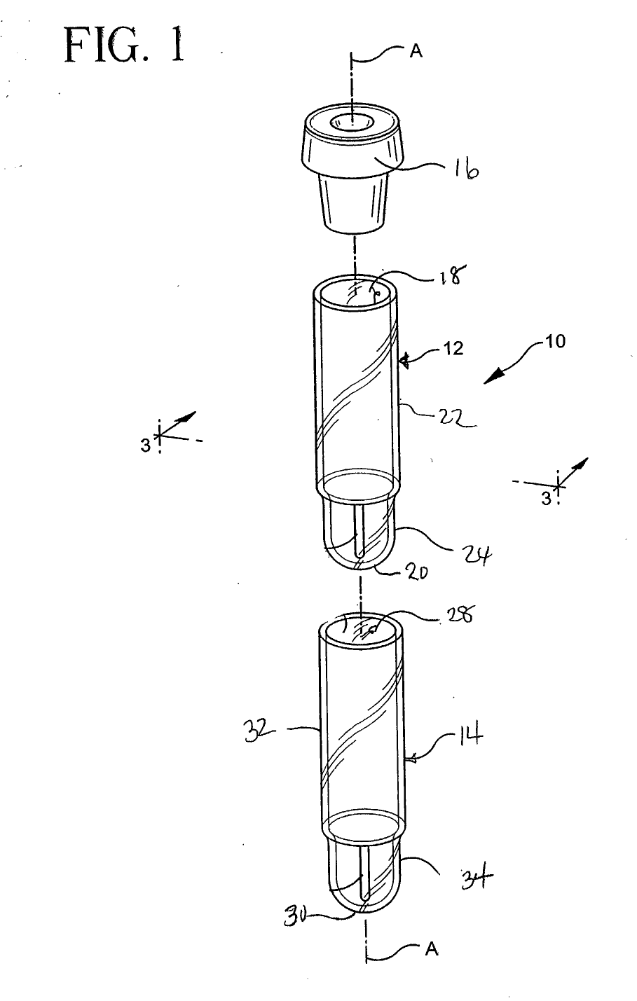

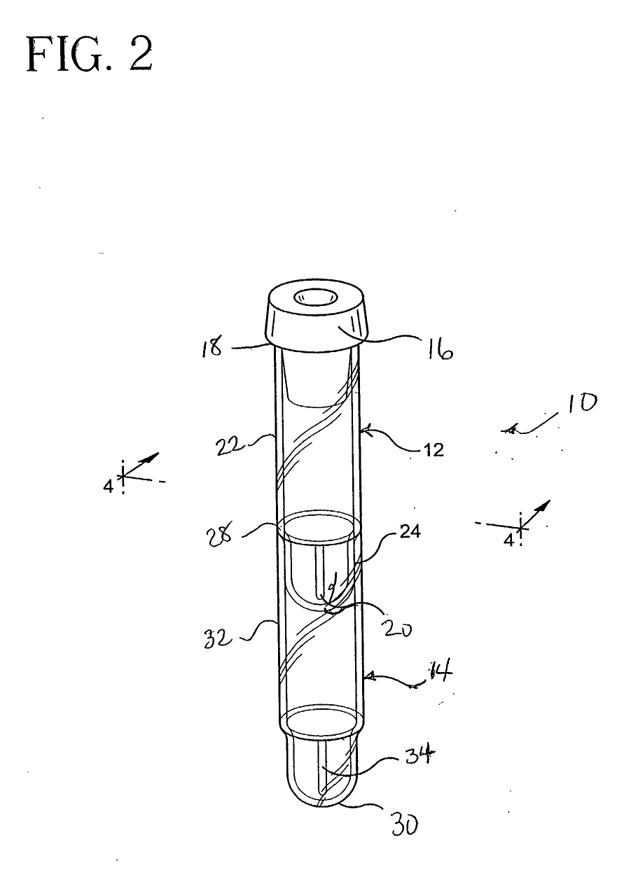

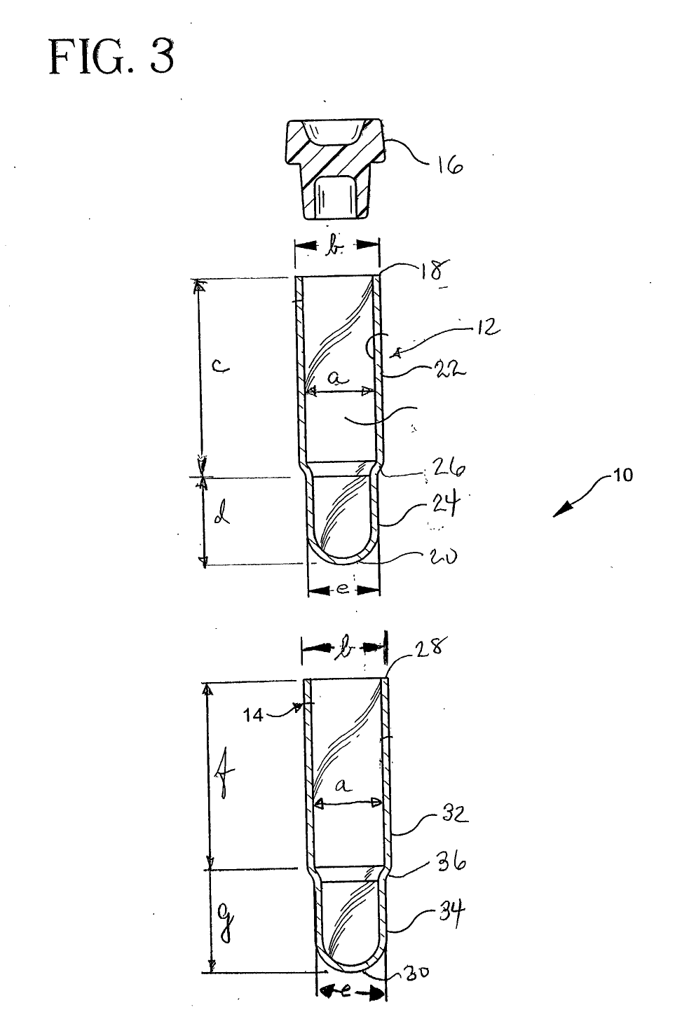

A tube assembly in accordance with the subject invention is identified generally by the numeral 10 in FIGS. 1-3. Tube assembly 10 comprises a first upper tube 12, a second lower tube 14 and a closure 16. Upper tube 12 is molded from a plastic material and includes an open top 18 and a semi-spherical closed bottom wall 20. A large diameter cylindrical upper side wall portion 22 extends from open top 18 toward closed bottom 20. Upper side wall portion 22 defines an inside diameter “a” and an outside diameter “b” as shown in FIG. 3. Upper tube 12 further includes a small diameter cylindrical lower side wall portion 24 that extends from bottom wall 20 toward open top 18. Lower side wall portion 24 is joined to upper side wall portion 22 by a generally radially aligned annular step 26. Upper side wall portion 22 and step 26 define a combined length “c”, and lower side wall portion 24 defines a length “d”. Additionally, lower side wall portion 24 defines an outside diameter “e” which is approximately equal to or slightly less than inside diameter “a” of upper side wall portion 22.

Lower tube 14 of tube assembly 10 includes an open top end 28 and a semi-spherical closed bottom wall 30. Lower tube 14 further includes a large diameter cylindrical upper side wall portion 32 that extends from open top end 28 toward closed bottom wall 30. Upper side wall portion 32 defines a length “f”, an inside diameter “a” and an outside diameter “b”. Thus, upper side wall portion 32 of lower tube 14 is cross-sectionally identical to upper side wall portion 22 of upper tube 12.

Lower tube 14 further includes a small diameter cylindrical lower side wall portion 34 that extends from bottom wall 30 of lower tube 14 toward open top end 28 thereof. Lower side wall portion 34 of lower tube 14 is joined to upper side wall portion 32 thereof by a generally radially aligned annular step 36. Lower side wall portion 34 and step 36 define a combined length “g” and lower side wall portion 34 has an outside diameter “e”. Thus, lower side wall portion 34 of lower tube 14 is cross-sectionally substantially identical to lower side wall portion 24 of upper tube 12.

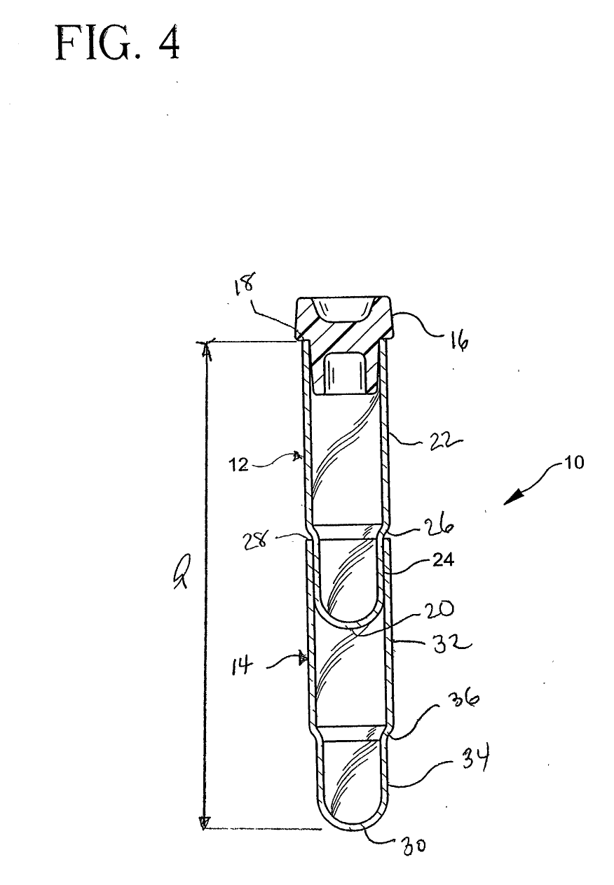

Tube assembly 10, in the assembled state shown in FIG. 4, defines an overall length “h” equal to the sum of the lengths “c”, “f” and “g”. The respective length dimensions of the upper and lower tubes are selected to achieve a combined length “h” that substantially conforms to an accepted length for prior art tubes, e.g., 75 mm, 100 mm or 125 mm. Thus, length “h” may be equal to 75 mm, 100 mm, or 125 mm.

Closure 16 of the tube assembly 10 may be of any conventional prior art design. For example, in the illustrated embodiment, closure 16 is unitarily molded from an elastomeric material that is substantially inert in the presence of materials that are apt to be stored in tube assembly 10 and that exhibits acceptable sealing characteristics.

In the illustrated embodiment of FIGS. 1-4, upper tube 12 and lower tube 14 are dimensionally substantially identical to one another. Thus, in this illustrated embodiment, length “c” for upper side wall portion 22 of upper tube 12 substantially equals length “f” for upper side wall portion 32 of lower tube 14. Similarly, length “d” for lower side wall portion 24 of upper tube 12 substantially equals length “g” for lower side wall portion 34 of lower tube 14. The lengths of upper and lower side walls may differ, however, depending whether annular step 26 and 36 are included in the length of the side wall; i.e., length “c” substantially equals length “f” when combined with the length of annular step 36. However, in other embodiments described and illustrated herein, the respective length dimensions of the upper and lower tubes differ.

Upper tube 12 and lower tube 14 are molded from different materials. More particularly, upper tube 12 is molded from a material that will exhibit appropriate characteristics for storing and protecting a specimen or pharmaceutical product therein. Tube assemblies 10 that are intended to rely upon a vacuum to draw a selected volume of blood into an evacuated container will provide upper tube 12 formed from PET in view of superior vacuum retention characteristics of PET. Lower tube 14, however, is provided primarily to achieve a selected overall length “h” for tube assembly 10. Hence, lower tube 14 may be formed from a less expensive material and a material that facilitates assembly with lower side wall portion 24 of upper tube 12. Thus, for example, lower tube 14 may be formed from polyethylene or polypropylene.

The differences between materials of upper tube 12 and lower tube 14 may be other than the type of plastic. Upper tube 12 and lower tube 14 may be different colors or shades, adapting to any desired differential desirable for analysis. For example, upper tube 12 may be formed from a highly transparent material that will enhance visual or electro-optical inspection of a specimen deposited in upper tube 12. However, lower tube 14 can be formed from a substantially opaque or black material that will aid interface with electronic detectors on automatic instruments. Additionally, lower tube 14 can be formed from a red plastic material to simulate the appearance of blood.

Certain diagnostic tests may require the specimens stored in upper tube 14 to be protected from degradation due to ultraviolet radiation. For example, specimens that will be subjected to bilirubin testing should be blocked from light. In these instances, upper tube 12 can be formed from a material that is amber or otherwise formed with light blocking characteristics or UV radiation blocking characteristics. Lower tube 14, however, can be formed from a conventional and less expensive plastic material.

Upper tube 12 need not be of unitary construction. For example, upper tube 12 may be formed by co-injection molding, co-extrusion or two-shot injection molding. Thus, upper tube 12 may be formed with adjacent layers of polypropylene and ethylene vinyl alcohol (EVOH) or adjacent layers of PET, PEN, or combinations thereof, and a cycloolefin copolymer (COC) to provide optimum moisture vapor and gas barrier properties for the particular specimen, tests and elapsed time for storage of the specimen in upper tube 12. Additionally, upper tube 12 can be formed with additional components, such as gels, anticoagulants or other coatings or inserts or with mechanical separators. The provision of these additional components in the relatively small upper tube 12 results in cost advantages as compared to prior art tubes that might coat an entire inner surface of a unitary tube of length “h”.

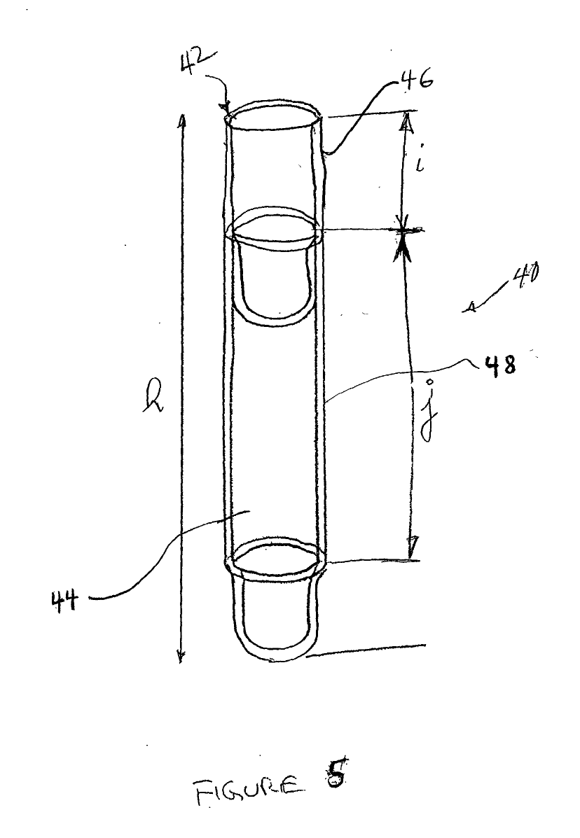

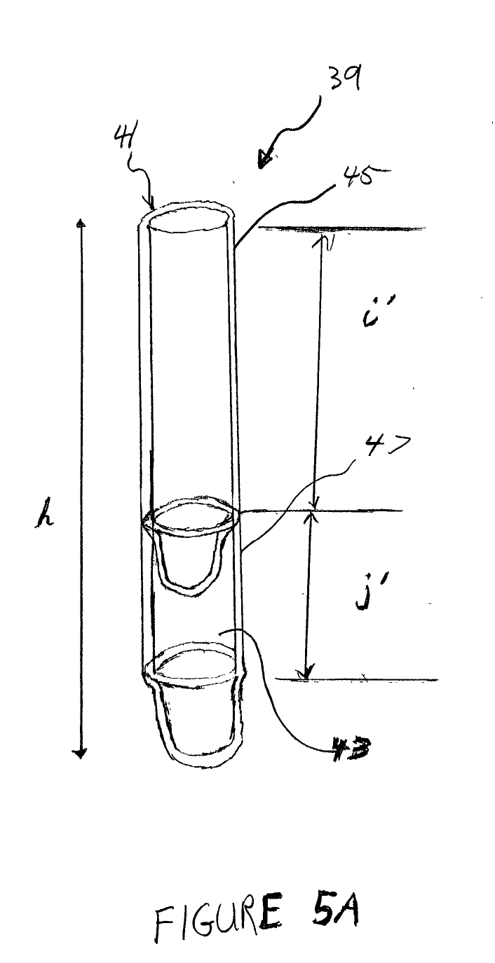

As noted above, tube assembly 10 of FIGS. 1-4 is formed from two tubes 12 and 14 that are dimensionally substantially identical to one another. However, identical dimensions are not required. In this regard, FIG. 5 shows tube assembly 40 which comprises an upper tube 42 and a lower tube 44. The assembly of upper and lower tubes 42 and 44 defines an overall length “h” that is substantially identical to length “h” of tube assembly 10 shown in FIGS. 1-4. However, upper tube 42 of tube assembly 40 has an upper side wall portion 46 of length “i” that is substantially shorter than the length of the upper side wall portion 22 of upper tube 12 shown in FIGS. 1-4. Conversely, lower tube 44 of tube assembly 40 shown in FIG. 5 has an upper side wall portion 48 with a length “j” that is substantially greater than length “f” for upper side wall portion 32 of lower tube 14 on tube assembly 10 shown in FIGS. 1-4. Thus, upper and lower tubes 42 and 44 of tube assembly 40 are not dimensionally identical and have lengths that are significantly different from one another. The shorter length of upper tube 42 necessarily results in a smaller volume for upper tube 42. The length, and hence the volume, for upper tube 42 is selected to slightly exceed the minimum required volume of a specimen required for a particular analytical test. Thus, as shown in FIG. 5, upper and lower tubes 42 and 44 can be selected to achieve a specified overall length “h” while still achieving a volume for upper tube 42 that will correspond to a required volume for a particular analytical test and that will achieve a substantially complete filling of upper tube 42 with that specified volume. The selection of material for the upper and lower tubes 42 and 44 may be made with consideration of the parameters discussed above with respect to the embodiment of FIGS. 1-4.

A further embodiment is shown in FIG. 5A where tube assembly 39 is shown which comprises an upper tube 41 and a lower tube 43. The assembly of upper and lower tube 41, 43 define an overall length “h” that is substantially identical to a length “h” of tube assembly 10 shown in FIGS. 1-4. However, upper tube 41 of tube assembly 39 has an upper sidewall portion 45 of length “i′” that is substantially longer than the length of upper sidewall portion 22 of upper tube 12 shown in FIGS. 1-4. Conversely, lower tube 43 of tube assembly 39 shown in FIG. 5A has an upper sidewall portion 47 with a length “j′” that is substantially shorter than length “f” for upper sidewall portion 32 of lower tube 14 on tube assembly 10 shown in FIGS. 1-4.

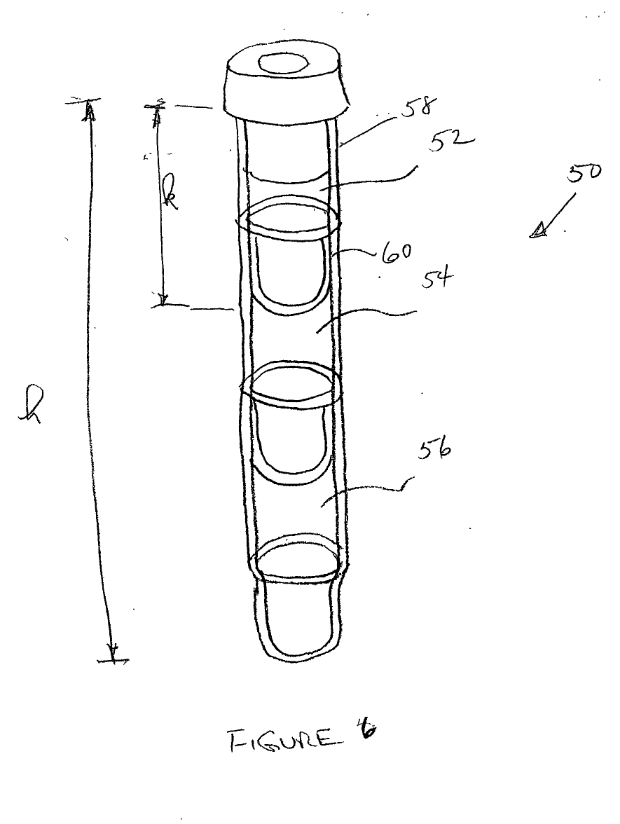

The embodiments of FIGS. 1-5 show tube assemblies with two tubes, namely, an upper tube and a lower tube. However, FIG. 6 shows a tube assembly 50 with a first upper tube 52, a second intermediate tube 54, and a third lower tube 56. Upper tube 52 has a large diameter cylindrical upper side wall portion 58 and a small diameter cylindrical lower side wall portion 60 that define an overall length “k” for upper tube 52. Length “k” and cross-sectional dimensions of upper tube 52 are selected to provide a volume for upper tube 52 that will enable the volume of a collected specimen to slightly exceed the specified volume for a particular test, while still ensuring that upper tube 52 will be filled completely. Intermediate tube 54 and lower tube 56 are dimensioned to achieve a specified overall length “h” that substantially conforms to overall length “h” of tubes 10 and 40 described above. Thus, tube assembly 50 is compatible with conventional storage equipment and conventional test equipment. As noted above, however, there are several optional conventional lengths permitted by available test equipment, with typical prior art tubes ranging in length from 75 mm to 125 mm. The length dimensions for intermediate tube 54 and lower tube 56 are selected to enable tube assembly 50 to achieve one standard dimension by employing all three tubes 52-56 or to achieve a shorter standard dimension by employing only upper tube 52 and intermediate tube 54.

The selection of materials for tubes 52, 54 and 56 of tube assembly 50 may be made in accordance with the parameters considered above. For example, upper tube 52 may be formed from material selected in accordance with characteristics of the collected specimen and the tests to be performed on the specimen. Thus, PET may be a preferred material for upper tube 52. Intermediate tube 54 and lower tube 56 may be formed from the same materials as each other, but different materials from upper tube 52. Typically, intermediate tube 54 and lower tube 56 will be formed from a less expensive material.

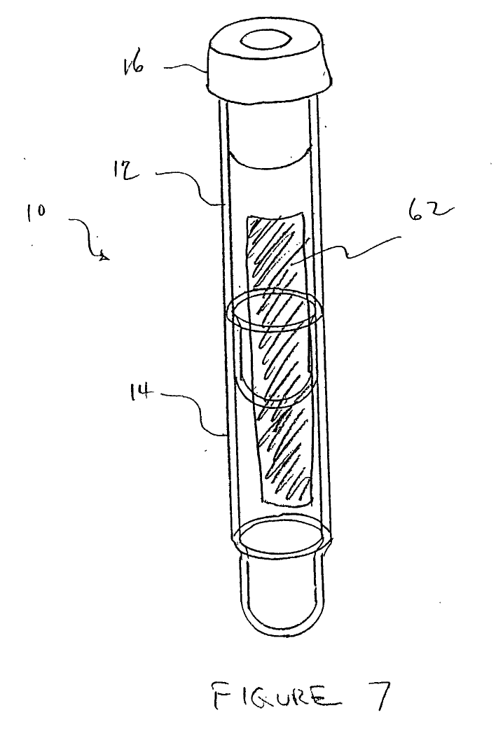

FIG. 7 shows a tube assembly 10 that is structurally and functionally identical to tube assembly 10 shown in FIGS. 1-4. However, tube assembly 10 of FIG. 7 is supplemented with a label 62 that extends from upper tube 12 to lower tube 14. Label 62 serves the conventional purpose of identifying the source of the specimen and the tests to be performed, while also functioning to hold upper and lower tubes 12 and 14 in their assembled condition. Label 62 may be adhesively applied across the outer surface of tube assembly 10. Alternatively, label 62 can be imprinted on the outer surface of tube assembly 10. Any movement or separation of upper and lower tubes 12 and 14 will be detected immediately by the label reader. Of course, other techniques for applying indicia to tube assembly 10 can be employed.

While there have been described what are presently believed to be the preferred embodiments, those skilled in the art will realize that changes and modifications may be made thereto without departing from the spirit of the invention, and it is intended to claim all such changes and modifications that fall within the true scope of the invention.

What is claimed is:

1. A tube assembly comprising first and second tubes, each said tube having an open top end, a bottom end and a tubular wall extending between said ends, said bottom end of said first tube being nested within said top end of said second tube, said first and second tubes being formed from different respective materials.

2. The tube assembly of claim 1, wherein said tubular side wall of said first tube is stepped to define a cross-sectionally small side wall portion adjacent said bottom end and a cross-sectionally larger side wall portion adjacent said top end, said cross-sectionally small side wall portion of said first tube being nested in portions of said second tube adjacent said open top end thereof.

3. The tube assembly of claim 2, wherein said bottom end of at least said first tube is closed.

4. The tube assembly of claim 3, wherein said bottom end of said second tube is closed.

5. The tube assembly of claim 1, wherein said first tube is formed from a material selected from the group consisting of PET, PEN, and combinations thereof.

6. The tube assembly of claim 5, wherein said first tube further comprises a layer formed from COC.

7. The tube assembly of claim 5, wherein said second tube is formed from polyethylene.

8. The tube assembly of claim 5, wherein said second tube is formed from polypropylene.

9. The tube assembly of claim 1, wherein said first tube is substantially transparent and said second tube is substantially opaque.

10. The tube assembly of claim 1, wherein said first tube is transparent and said second tube is formed from a colored plastic material, whereby said colored plastic material is selected to facilitate a test to be performed on materials stored in said first tube.

11. The tube assembly of claim 1, wherein said first tube is formed from a colored plastic material.

12. The tube assembly of claim 1, wherein said first and second tubes are dimensionally substantially identical.

13. The tube assembly of claim 1, wherein said first and second tubes each define a length extending from said open top to said bottom, said length of said first tube being different than said length of said second tube.

14. The tube assembly of claim 13, wherein said length of said first tube is less than said length of said second tube.

15. The tube assembly of claim 13, wherein said length of said first tube is greater than said length of said second tube.

16. The tube assembly of claim 1, wherein said first tube includes a first laminated layer of polypropylene and a second laminated layer of EVOH.

17. The tube assembly of claim 1, wherein said first tube is permanently nested within said top end of said second tube.

18. The tube assembly of claim 1, wherein said first tube is removably nested within said top end of said second tube.

19. The tube assembly of claim 1, wherein said tube assembly has a length of 75 mm.

20. The tube assembly of claim 1, wherein said tube assembly has a length of 100 mm.

21. The tube assembly of claim 1, wherein said tube assembly has a length of 125 mm.

22. A tube assembly comprising first and second tubes, each said tube having an open top end, a bottom end and a tubular wall extending between said ends, said bottom end of said first tube being nested within said top end of said second tube, said first and second tubes being different colors.

23. A tube assembly comprising an upper tube, an intermediate tube, and a lower tube,
said upper tube having an open top, a closed bottom and a tubular side wall extending between said top and said bottom, said side wall comprising a diametrically small lower portion adjacent said bottom, a diametrically large upper portion adjacent said top and a step between said upper and lower portions, said upper tube being formed from a first selected material,
said intermediate tube having an open top, a bottom and a tubular side wall extending between said top and said bottom, said lower portion of said upper tube being nested in the open top of said intermediate tube,
said lower tube having an open top, a bottom and a tubular side wall extending between said top and said bottom, portions of said intermediate tube adjacent said bottom of said intermediate tube being nested in portions of said lower tube adjacent said open top, wherein said intermediate tube and said lower tube are formed from a material different than said first selected material.

24. The tube assembly of claim 23, wherein the lower tube is removably nested with the intermediate tube.

25. The tube assembly of claim 24, wherein the upper tube and the intermediate tube define a combined length of approximately 75 mm.

26. The tube assembly of claim 25, wherein the upper tube, the intermediate tube and the lower tube define a combined length of 100 mm.

27. The tube assembly of claim 25, wherein the upper tube, the intermediate tube and the lower tube define a combined length of 125 mm.
